(19) United States
(12) Patent Application Publication
(10) Pub. No.: US 2013/0181567 A9
(43) Pub. Date: Jul. 18, 2013

(54) HYBRID SYNCHRONOUS MOTORS AND CURRENT-ENERGIZED SYNCHRONOUS MOTORS SUITABLE FOR VEHICLE DRIVES

(71) Applicants: Andreas Holzner, Inzell (DE); Verena Mathoy, Grabs (CH); Anna Mathoy, Grabs (CH); Eva Mathoy, Grabs (CH)

(72) Inventors: Andreas Holzner, Inzell (DE); Arno Mathoy, Grabs (CH)

(73) Assignee: BRUSA ELEKTRONIK AG, Sennwald (CH)

(21) Appl. No.: 13/455,173

(22) Filed: Apr. 25, 2012

Related U.S. Application Data
(63) Continuation-in-part of application No. PCT/IB2011/053024, filed on Apr. 7, 2011.
Application No. PCT/IB2011/053024 is a continuation-in-part of application No. 12/675,780, filed on Feb. 27, 2010, now Pat. No. 8,198,776.
(60) Provisional application No. 61/363,199, filed on Jul. 9, 2010.
(60) Provisional application No. 60/969,628, filed on Sep. 2, 2007.

(30) Foreign Application Priority Data
Aug. 28, 2007 (DE) 102007040750.7
Jul. 9, 2010 (EP) 10169115

(51) Int. Cl. H02K 1/27

(52) U.S. Cl. 310/156.53

(57) ABSTRACT

Laminated rotor (21) assemblies for rotating electric machines such as hybrid synchronous motors (HSM) of vehicle drives, the rotor plates (26) of which have one or several recesses (29) as a flux barrier or magnet pocket, which comprise radially innermost and outermost edge sections as rounded transition regions from and to edge sections lying therebetween. Each of the rounded transition regions may be shaped at least approximately respectively according to a part of a curve (35) of second order. Between adjacent recesses (29), a respective oblique cross-piece (52) is provided, the center line (54) of which lies obliquely to the pole axis (30).

### CROSS REFERENCE TO RELATED APPLICATIONS

This application claims benefit as a C-I-P continuation-in-part of copending U.S. application Ser. No. 12/675,780 filed on Feb. 27, 2010 as a 35 U.S.C. 371 national stage entry of PCT International App. No. PCT/1B2008/053462 filed on Aug. 28, 2008, claiming benefit of priority to German (DE) application no. 102007040750.7 filed on Aug. 28, 2007, and also claiming benefit of priority as a non-provisional of U.S. provisional application No. 60/969,628 filed on Sep. 2, 2007; the present application also claims benefit as a C-I-P continuation-in-part of copending PCT International App. No. PCT/182011/053024 filed on Jul. 7, 2011, claiming benefit of priority to European (EPO) application no. EP10169115 filed on Jul. 9, 2010, and also claiming benefit of priority as a non-provisional of U.S. provisional application No. 61/363,199 filed on Jul. 9, 2010; the entireties of parent U.S. application Ser. No. 12/675,780 and of PCT International Application No. PCT/1B2008/053462, as well as the entireties of parent PCT International App. No. PCT/182011/053024 and of European (EPO) application no. EP10169115 and U.S. provisional application No. 61/363,199 are all expressly incorporated herein by reference in their entireties and as to all their respective parts, for all intents and purposes, as if all set forth identically in full herein.

### FIELD OF THE INVENTION

The present invention relates to hybrid synchronous motors and to current-energized synchronous motors which are suitable for vehicle drives. The invention also relates to laminated rotors for rotating electric machines and for highly stressed hybrid synchronous motors (HSM) of vehicle drives. Furthermore, in aspects the invention relates to special configurations of the geometries of rotor plates in electric motors, usable, for example, to drive electric vehicles.

### PRIOR ART

Since the mid 90's of the previous century, automobile manufacturers and designers were increasingly concerned with hybrid drives for cars and sports cars as well as commercial vehicles. The hybrid drive combines an internal combustion engine with an electric motor (and optionally with a flywheel). If a small internal combustion engine (range extender) is used only for power generation for the main electric drive, the term series hybrid is used.

Furthermore, since battery technology has shown significant progress for some years, battery electric vehicles (BEVs) are also experiencing a new revival.

In the case of vehicle drives where the electric motor provides a significant part of the propulsion power, or such a motor is the sole drive unit, the power output is intended to take place in wide speed and load range with as high an efficiency as possible.

According to the prior art, the asynchronous motor (ASM), a particular design of the permanent-magnet synchronous motor (PSM), and the switched reluctance motor (SRM) are distinguished in particular here. The preferred design of the PSM is based on the position of the magnets in the interior of the rotor (internal permanent magnet motor IPM). Considering the SRM, reference DE-A-10207267 describes a reluctance motor having a rotor which consists of a multiplicity of laminated segments which are joined via non-magnetic connecting elements to result in a unit. The connecting elements act as flow barriers. Non-magnetic connecting elements are, as a rule, more expensive than connecting elements of standard steel or have to be made with larger dimensions in order to achieve the same strength values as steel.

Considering synchronous reluctance motors (SyR), reference DE-A-10004175 describes a synchronous reluctance motor having continuous flow barriers. Synchronous reluctance motors (SyR) which are operated with three-phase currents and have a stator similar to that of asynchronous motors are suitable in practice, owing to their simple and robust design (no rotor windings or magnets), for economical industrial drives having a stator diameter of from 150 to 400 mm. Disadvantages are the relatively low torque density in relation to other motor types and a poor power factor, which significantly complicates their use in the vehicle and therefore limits them to stationary applications.

Considering sine-wave motors, according to earlier research (i.e., the final report of “Antriebsentwicklung [Drive development]” at www.brusa.biz), an advantage of sine-wave machines is their constant torque output over the angle of rotation and the low noise development from harmonic fields relative to square-wave motors. This also manifests itself in a constant power uptake from the power source (battery or motor inverter).

If the motor inverter takes its power directly from a battery (battery link), the harmonic fields would, in the case of square-wave motors, result in alternating loads which cause additional losses at the internal resistance of the battery. Since the sine-wave motors have no harmonic fields and thus achieve a constant power uptake over the angle of rotation, they also cause no additional losses at the internal resistance of the supply battery.

In the narrower choice for a main drive system in which the motor inverter takes its power directly from a battery, types having a sinusoidal air-gap field distribution, such as the asynchronous motor (ASM) and the internal permanent magnet synchronous motor (IPM), are therefore particularly suitable, according to the prior art.

Considering current-energized synchronous motors, as is known, the current-energized synchronous motor (CSM) has a similar stator in comparison with other sine-wave motors. However, the rotor is provided with pronounced poles (non-salient poles or salient poles) with which rotor windings through which direct current flows are coordinated. In current-energized synchronous motors, the energizer power in the rotor must therefore be fed from the outside. The transmission can take place in a non-contact manner (via transformer) in large machines. In the case of smaller motors for vehicle drives, which have a stator diameter from 150 mm to 400 mm, and in the case of those in which a large dynamic range of the rotor current regulation is required, it takes place via brushes and slip rings. Thus, the CSM, together with the direct current motor (DCM) are among the brush-type motors in which power transmission takes place via brushes to the rotor.

A reference to some basic properties of all synchronous motors may prove helpful to readers. The rotor of every synchronous motor rotates synchronously with the field of the stator current. If the rotor cannot rotate with the stator frequency, or the stator field cannot adapt to the rotor position, the asynchronous superposition of the rotor and stator fields produces only pendulum moments. When they are used as a vehicle drive, all types of synchronous motors therefore require, in principle, a frequency inverter controlled via the rotor position.

Considering further the basic properties of conventional current-energized synchronous motors, with dynamic energizing, current-energized synchronous motors achieve 2.5 times their nominal moment for about 30 seconds and up to 4 times their nominal moment for about 5 seconds. With their short-term moment, they surpass permanent-magnet synchronous motors of the same size in most cases. The difference is pronounced particularly when a comparison is made with synchronous motors having buried magnets (IPM). In these, the magnets are inserted into slots of the rotor lamellae.

Regarding power transmission via brushes in the CSM, brush-type motors were frequently also not considered because, according to the prevailing argumentation and conventional wisdom, this technology would be difficult to market in an innovative product, and furthermore, lifetime limitations existed due to the mechanical brush wear and were to be feared.

As part of a general prejudice, frequently a sufficient distinction is not made between the commutator of a direct current motor (DCM) and the comparatively simple slip ring of a current-energized synchronous motor (CSM). While the total motor power has to be transmitted to the rotor via the commutator in the case of a DCM, the energizer power to be transmitted to the slip ring of the CSM is only in the low one-digit percentage range of the total motor power. In the case of the CSM, as in the case of all other synchronous motors for vehicle drives, the actual electrical motor power is transmitted to the stator via the frequency inverter.

Exploring some of the disadvantages of the CSM according to the prior art, it should be understood that the torque of a current-energized synchronous motor that is operated without energizing (emergency torque) arises exclusively from the reluctance. The reluctance is a dimensionless variable and is determined by the ratio of the inductance of the longitudinal axis Ld to the inductance of the transverse axis Lq. In salient-pole motors, Ld>>Lq, Ld, the longitudinal inductance, being determined mainly by the air gap, and Lq, the transverse inductance, being determined mainly by the pole geometry.

Thus, if, in a current-energized synchronous motor, the energizing fails, only about a one-quarter of the nominal moment can be established in the case of conventional salient-pole motors, and no moment at all in the case of non-salient-pole motors. This may lead to dangerous driving situations under certain circumstances.

Poor or lacking emergency running properties therefore constitute a further reason why those skilled in the art believed the current-energized synchronous motor (CSM) to be substantially unsuitable as a vehicle drive (i.e., for example the final report cited above).

Considering the prior art further, an electric machine is known from publication WO01/48890A1, in which the stator or the rotor has radial tooth modules/poles which are separated from each other. In order to increase the reluctance, each tooth module/pole is provided with a reluctance barrier which is constructed as a radial and axially extended gap in the pole shoe.

As is known, the electric motors in the main drive of electric cars or hybrid cars often operate up to rotation speeds of approximately 12000 rpm. These high rotation speeds bring about very great centrifugal forces on the periphery. Considering the CSM in this context, originally, such current-excited synchronous motors or generators were employed for large motors or generating plants, where the rotation speeds are a fraction of the above-mentioned value. The current-excited synchronous motor differs from the other types of motor used hitherto in an electric car (e.g. asynchronous and permanent magnet synchronous motors) most significantly by a wound and current-excited rotor.

Given the very high centrifugal forces which act on the pole caps and are produced not least by the weight of the copper windings, in the new application for electric cars the poles/pole shoes or plate stacks of the CSM rotor are particularly highly stressed. Owing to the high centrifugal forces, that are produced, inter alia, by the winding, and that act with leverage force on the pole caps, high notch stresses occur in the region of slots acting as a flux barrier, namely at the geometric transitions from the horizontal into the vertical. Furthermore, with the configuration of conventional roundings (circular in shape), enormous stress peaks also occur, and namely at the transitions from the circular rounding to the straight line. Nowadays, these stress peaks restrict the possibility for further development of the rotor geometry in a CSM, or prevent high rotation speeds. Conventional methods, such as for example the application of Kevlar cages, welded or screw constructions or the like which are intended to increase the stability of the rotor, however, have a performance-reducing effect.

Similar effects also occur, however, in known hybrid synchronous motors (HSM) employed for the main drive in the field of automobiles, in which HSMs recesses are provided for buried magnets and/or punched-out flux barriers are provided.

Another problem in the rotor geometry of the conventional CSMs lies in that the plate stacks of the rotor, likewise under the rotation speed-induced centrifugal forces, with identical dimensioning lift themselves earlier from the shaft than in comparable electric motors with closed rotor plate stacks. The effect of the lifting from the shaft consequently likewise limits the possible rotation speed. While the lifting effect is less pronounced in machines with a closed pole structure (e.g. HSM), it remains considerable.

Therefore, an improved lifting behaviour, i.e., less easy releasing of the plate stack from the shaft, is also desirable. The lifting behaviour of the rotor plates could theoretically be influenced by a greater interference fit between shaft and rotor plate. However, the stress on the plate geometry would be additionally increased in the region of the radial slits, a consequence which is not desirable for the reasons previously mentioned. Therefore, the effects of lifting and notch stresses or respectively increased contact pressure between rotor plate stack and shaft, and increased notch stress play against each other in a disadvantageous manner.

Thus, it could be defined as a superordinate objective, to find a rotor structure that has no centrifugal force-induced problems at high rotation speeds (e.g. approximately 12000 rpm). Considering prior reference US20070096578A1, it discloses a rotor for electric machines. However, this solution deals expressly only with the edge paths of the recesses of the rotor plate immediately adjoined by the outer rotor periphery, wherein exclusively the curved end part of the recess is configured circularly or, if applicable, elliptically. According to prior US20100045121A1, a cobalt alloy was used for the magnet circuits, to increase the magnetic saturation in electric motor construction.

None of the indicated previously known technologies satisfactorily resolved the problems which are posed.

### SUMMARY OF THE INVENTION

In aspects, the invention relates to the context of solving the problem of creating an improved rotor geometry, by which the above-mentioned disadvantages of the prior art may be reduced or eliminated, i.e., by which on the one hand the stress peaks, in particular the notch stresses in the rotor—despite high centrifugal forces—may be significantly reduced. On the other hand, through the invention also the lifespan and the torque of the rotor or of the electric motor are to be increased, and therefore also the lifting behaviour is to be positively influenced, or reduced.

In versions, the invention proceeds from a laminated rotor for rotating electric machines, in particular for a hybrid synchronous motor of vehicle drives, the rotor plates of which have one or several recesses as flux barrier or magnet pocket. The radially innermost and outermost edge sections of these recesses (rounded transition regions) comprise edge sections lying therebetween, wherein at least one of these transition regions is configured in a circular or ellipse shape. According to the invention, each of the rounded transition regions may be shaped at least approximately respectively according to a part of a curve of second order, on the other hand between the adjacent recesses in each case an oblique cross-piece is provided, the centre line of which lies obliquely to a pole axis and forms here with the pole axis preferably an angle of approximately 20°-50°, in particular 30°.

The term “curve of second order” is to be understood in this application to mean, both in the description and also in the claims, a geometric figure of a curve which can be designated as a conic section, and which is configured elliptically, parabolically or hyperbolically (i.e., not circularly or angularly).

This rotor plate geometry is suitable in particular for a fast-running HSM or CSM.

In the CSM, the rotor comprises at least two rotor poles, each with an exciter winding and in each rotor pole at least one magnetic flux barrier in the form of a radial slit. In the HSM, per rotor pole at least one magnet is housed in a magnet pocket and the lamination also has at least one flux barrier.

Our calculations [by means of the Finite Element Method (FEM)] and tests confirmed that the shape of an ellipse in the recess transition region involves the least stresses. In the opinion of the inventors, this is attributable to the continuous alteration of the distance from the intersection of the main axis of the ellipse. (This corresponds to a continuous alteration of the radius). By systematic determination of height and width, the ellipse can be optimized geometrically with respect to as minimal a notch stress as possible. As the use of two cooperating circular roundings with different radii represents a good approximation to the ellipse, thereby a distinct improvement compared to a pure circular rounding can already be achieved. Through the elliptical configuration of the transition regions of the recesses, the lifespan of the rotor is increased and the risk of fracture induced by centrifugal force is reduced.

An effective deflection of the flux of force desirably takes place in the transition region or, respectively, a reduction of the notch effect, which does not even allow stress peaks to occur in the dangerous zone at all. Through the use of the ellipse shape with its continuous distance increase, this takes place in a particularly harmonious manner. (The term “distance” is to be understood in each case to mean a distance from the intersection of the main axis of the ellipse.) The condition for fulfilling the function of the continuous distance increase could also be designated as “distance gradient”. This continuous distance increase as a condition could, however, in addition to the ellipse, also be fulfilled by parabola (quadratic function), polynomials of higher order, or as an approximation to the ellipse by two radii continuing tangentially into each other, with a different value.

This part of the invention therefore basically may be used advantageously in all electric motors with radial slits, magnet pockets and/or other recesses, in which notch stresses occur. In this respect, the invention is not merely restricted to CSM or HSM, but rather it can be used expediently in any rotor geometry having recesses.

In the preferred exemplary version, alternatively to iron-silicon plates, at least the rotor plates, to increase the rotor torque that is achievable, are produced from an iron-cobalt alloy, preferably with a proportion of 50% cobalt and 50% iron. Through this measure, the torque e.g. of a HSM may therefore be further increased and hence the power density may be increased significantly.

In an exemplary version of a CSM, the radial slot is divided—in its longitudinal axis—by a transversely arranged bridge into two or several regions, wherein the radially inner first slit part is configured as a first flux barrier, if applicable to receive a permanent magnet, and the radially outer second slit part is configured as a second flux barrier, if applicable also to receive a permanent magnet. Through the permanent magnet, the rotor iron of the rotor plates—at the bridges or respectively at the remaining connection sites—is saturated, so that these regions for the magnetic flux act as a division of the pole. Thereby, the effect of the magnetic field lines can be optimized in the rotor pole.

In an expedient version, at least the radially inner end of the two slit parts for the continuous distance increase is configured elliptically and/or parabolically and/or with two radii continuing into each other tangentially. The radially outer end of the first slit part can also be configured elliptically and/or parabolically and/or with two radii continuing into each other tangentially as an approximation to an ellipse.

If applicable—alternatively or additionally—the radially outer slit part may also receive a permanent magnet.

In some preferred exemplary versions of the invention, the curves of second order in the transition regions in all recesses and contour sections of the rotor plate may be configured elliptically or approximately to an ellipse. In additional preferred exemplary versions, there is a rotor piece having at least one salient pole that has a shank, said shank having a radial shank axis, and said at least one salient pole having a shoe. There is a radially-extending longitudinal slot in said at least one salient pole, said radially-extending longitudinal slot having a central slot axis coincident with said shank axis, said radially-extending longitudinal slot having first and a second lateral side surfaces, the distance between said first and second lateral side surfaces defining a slot width. Furthermore, there is a radially-outermost edge section of said radially-extending longitudinal slot, said radially-outermost edge section located at a radially outer end of said radially-extending longitudinal slot. This radially-outermost edge section includes a curved outermost transition region having profile shape at least approximately in form of a curve of second order. A radially-innermost edge section of said radially-extending longitudinal slot is located at a radially inner end of said radially-extending longitudinal slot. This radially-innermost edge section includes a curved innermost transition region having profile shape at least approximately in form of a curve of second order. A bridge spanning the slot width and connected to said first and said second lateral side surfaces divides said radially-extending longitudinal slot into a first radially-inner slot portion and a second radially-outer slot portion; said first slot portion having a respective curved outer transition region having profile shape at least approximately in form of a curve of second order. The second slot portion has a respective curved inner transition region having profile shape at least at least approximately in form of a curve of second order, and a permanent magnet is in said first slot portion. This permanent magnet generates flux saturating said bridge to create high resistance for further magnetic flux in said bridge and to reduce magnetic conductivity of said bridge, so as to extend the effect of said magnetic flux barrier to a total region of a longitudinal axis of said at least one salient pole. The second radially-outer slot portion is preferably an empty (vacant) space flux barrier, or may have a second permanent magnet therein.

Preferably, the recesses in the rotor poles are configured as radial slots, wherein the curve of second order is arranged as an ellipse in the radial slit tangentially and symmetrically. Here, a main axis of the tangential ellipse, which defines the rounding, can preferably be configured greater by 40-60% than a width of the radial slit, and a secondary axis of the ellipse can preferably be configured smaller by 70-80% than the width of the slit.

If applicable, however, the curves in the transition regions may be configured parabolically, hyperbolically, therefore according to a polynomial of higher order (third or higher order), or with two radii continuing tangentially into each other with a different value—as an approximation to the ellipse—, in order to achieve an improvement compared with conventional pure radii in the transition regions. Thus, in the aforementioned additional preferred exemplary versions, said curved outermost transition region's profile shape, and said curved innermost transition region's profile shape, and said curved outer transition region's profile shape, and said curved inner transition region's profile shape, each may include a respective profile shape selected from the group consisting of an elliptical profile, a parabolic profile, and a higher-order polynomial profile.

In yet additional preferred exemplary versions of the invention, there is a rotor piece having at least one salient pole that has a shank, said shank having a radial shank axis, and said at least one salient pole having a shoe. A radially-extending longitudinal slot in said at least one salient pole has a central slot axis coincident with said shank axis. This radially-extending longitudinal slot has first and second lateral side surfaces, the distance between said first and second lateral side surfaces defining a slot width. A radially-outermost edge section of said radially-extending longitudinal slot is located at a radially outer end of said radially-extending longitudinal slot, and said radially-outermost edge section includes a curved outermost transition region having profile shape at least approximately in form of a curve of second order. Furthermore, a radially-innermost edge section of said radially-extending longitudinal slot is located at a radially inner end of said radially-extending longitudinal slot. This radially-innermost edge section includes a curved innermost transition region having profile shape at least approximating an ellipse perimeter formed by an ellipse having major diameter of length greater than said slot width by a range of 40-60% and having minor diameter length smaller by a range of 70-80% than said slot width. There is a bridge spanning the slot width and connected to said first and said second lateral side surfaces, this bridge dividing said radially-extending longitudinal slot into a first radially-inner slot portion and a second radially-outer slot portion. A permanent magnet is located in said first slot portion. It is further advantageous if permanent magnet generates flux saturating said bridge to create high resistance for further magnetic flux in said bridge and reduce magnetic conductivity of said bridge so as to extend the effect of said magnetic flux barrier to a total region of a longitudinal axis of said at least one salient pole. In turn, the second radially-outer slot portion is either preferably an empty-space flux barrier, or may have a second permanent magnet therein.

In variations of these additional preferred exemplary versions of the invention, it may be additionally advantageous configure said curved outermost transition region's profile shape to include a profile shape selected from the group consisting of an elliptical profile, a parabolic profile, and a higher-order polynomial profile. Or, to configure said first slot portion to have a respective curved outer transition region having profile shape at least approximating a respective ellipse perimeter formed by a respective ellipse having a respective major diameter of length greater than said slot width by a range of 40-60% and having a respective minor diameter length smaller by a range of 70-80% than said slot width. Or, to configure said second slot portion to have a respective curved inner transition region having profile shape at least approximating a respective ellipse perimeter formed by a respective ellipse having a respective major diameter of length greater than said slot width by a range of 40-60% and having a respective minor diameter length smaller by a range of 70-80% than said slot width. In additional variations, it may be afford advantage to configure the respective minor diameter of said respective ellipse perimeter of said curved outer transition region of said first slot portion to be smaller than said minor diameter of said curved innermost transition region's ellipse perimeter, or additionally, to configure said respective minor diameter of said respective ellipse perimeter of said curved inner transition region of said second slot portion to be smaller than said minor diameter of said curved innermost transition region's ellipse perimeter.

In these exemplary versions, it may be further advantageous to locate an outermost point of the radial slit arranged at a radial distance from the outer shell of the rotor pole, the value of which preferably lies between 0.6-0.7 mm (in order to bear the 12000 rpm with this rotor size). This arrangement may be stated alternatively by indicating that said radially-outermost edge section of said radially-extending longitudinal slot has a radially-maximal extent spaced in the range of 0.6-0.7 mm from an outer periphery of said at least one salient pole.

Further according to the invention, therefore in each case an oblique cross-piece is provided between adjacent recesses (e.g. between magnet pockets and flux barriers). Thereby, the cross-pieces with the greatest stresses are stressed more strongly to tension and less to bending. This results in a reduced notch stress, whereby the risk of fracture of the cross-pieces is significantly reduced. It is additionally expedient if the oblique cross-pieces are configured to be as narrow as possible, in order to thereby at the same time make possible a magnetic saturation thereof more quickly, which in turn increases the performance of the motor, as the magnet mass which is used can be utilized more effectively.

Thus, in further developments, the invention may advantageously include a rotor piece having a central axis, and having a radial extent from said central axis. A first magnet pocket recess is disposed in said rotor piece and transversely to a radius of said rotor piece. This magnet pocket recess has a major axis coinciding with a chord segment of a rotor circle delineated by said radial extent. The magnet pocket recess has a radially-outer top wall and a radially-inner bottom wall. It also has a first end closing between said radially-outer top wall and said radially-inner bottom wall, as well as a second end closing between said radially-outer top wall and said radially-inner bottom wall. A first flux barrier recess is located proximate to said first end and is separated from said first end by a first oblique crosspiece lying obliquely at an angle in the range of 10°-50° relative to a radius of said rotor piece that passes through a center of said magnet pocket recess, said first flux barrier recess having a respective upper wall and a respective lower wall. A second flux barrier recess is located proximate to said second end and is separated from said second end by a second oblique crosspiece lying obliquely at an angle in the range of 10°-50° relative to a radius of said rotor piece that passes through a center of said magnet pocket recess. This second flux barrier recess has a respective upper wall and a respective lower wall. A pocket recess first outer transition region lies between said radially-outer top wall and said first end. A pocket recess first inner transition region lies between said radially-inner bottom wall and said first end. A pocket recess second outer transition region lies between said radially-outer top wall and said second end. A pocket recess second inner transition region lies between said radially-inner bottom wall and said second end. A first flux barrier upper transition region lies between said first flux barrier respective upper wall and said first oblique crosspiece. A first flux barrier lower transition region lies between said first flux barrier respective lower wall and said first oblique crosspiece. A second flux barrier upper transition region lies between said second flux barrier respective upper wall and said second oblique crosspiece. A second flux barrier lower transition region lies between said second flux barrier respective lower wall and said second oblique crosspiece. Each of said transition regions preferably has a respective profile shape at least approximately in a respective form of a respective curve of second order. As a variation, each transition region's profile shape may include a respective profile shape selected from the group consisting of an elliptical profile, a parabolic profile, and a higher-order polynomial profile; or, each transition region's profile shape is a respective elliptical profile. Within these developments of the invention as well, it should again be understood, as previously referred to, that the rotor piece may advantageously be produced from an iron-cobalt alloy.

In a preferred exemplary version, the radially outwardly lying recesses have a ham- or kidney-like contour for an increased deflection or respectively a concentration of magnetic flux lines in radial direction.

In further developments, the invention may advantageously include an outer magnet pocket recess disposed in said rotor piece and transversely to a radius of said rotor piece, this outer magnet pocket recess having a respective major axis parallel to the major axis of the first magnet pocket recess. This outer magnet pocket recess has a respective radially-outer top wall and a respective radially-inner bottom wall. It also has a respective first end closing between its respective radially-outer top wall and its respective radially-inner bottom wall, as well as a second end closing between its respective radially-outer top wall and its respective radially-inner bottom wall. A first radially outwardly lying recess is located proximate to said first end, this first radially outwardly lying recess having a ham-like or kidney-like contour. A second radially outwardly lying recess is located proximate to said second end this second radially outwardly lying recess has a ham-like or kidney-like contour. As will be readily understandable, in advantageous variations, there may be: an outer magnet pocket recess first outer transition region between said outer magnet pocket recess radially-outer top wall and said outer magnet pocket recess first end; an outer magnet pocket recess first inner transition region between said outer magnet pocket recess radially-inner bottom wall and said outer magnet pocket recess first end; an outer magnet pocket recess second outer transition region between said outer magnet pocket's radially-outer top wall and said outer magnet pocket's second end; and, an outer magnet pocket recess second inner transition region between said outer magnet pocket's radially-inner bottom wall and said outer magnet pocket's second end. Each of these outer magnet pocket's transition regions may advantageously have a respective profile shape at least approximately in a respective form of a respective curve of second order. As shall be further readily understandable, in variants, each respective transition region of said outer magnet pocket's transition regions may advantageously include a respective profile shape selected from the group consisting of an elliptical profile, a parabolic profile, and a higher-order polynomial profile. Or, as a variant, each transition region's respective profile shape may be a respective elliptical profile.

A HSM (or CSM) with the rotor of plates of a cobalt/iron alloy with flux barriers which are rounded in the notches elliptically, or approximately elliptically, or respectively according to a curve of second order, therefore creates a surprising improvement in power density per space or per weight, which is an important criterion in electric car construction for vehicle drives.

In aspects, the invention also seeks improvement of the CSM emergency running properties by increasing the reluctance, by providing improved solutions via which the above disadvantages of the prior art in the case of current-energized synchronous motors (CSM) may be significantly reduced or eliminated. The current-energized synchronous motor is further developed so that it can produce a significant torque for driving a vehicle in emergency operation without energizing. Thus, in aspects the invention therefore significantly increases the torque without energizing by current (reluctance moment) in the case of the current-energized synchronous motor (CSM).

In versions, there is at least one selective magnetic flux barrier, particularly in the form of a radial slot, provided along the main axis of the rotor pole for increasing the reluctance moment in each rotor pole. According to a further development, the rotor poles are preferably in the form of salient poles. Such flux barriers increase the magnetic resistance for flux lines in the q-axis (quadrature axis) and thus effect an increase in the reluctance.

Considering the technical preconditions for an improvement in the CSM, against the background described previously, the conventional current-energized synchronous motor was used as a starting point and an object was to further develop it for vehicle drives. It was found that the following important preconditions are essential for improving the emergency running properties of the current-energized synchronous motor:
a magnetic barrier along the main axis or d-axis of the rotor pole, which
greatly reduces the inductance of the transverse axis (Lq) but which
leaves the inductance of the main axis (Ld) at its originally high value, with the result that
a large increase in the Ld/Lq ratio, the reluctance, occurs, and, the torque is increased several times, for example by a factor of four, without energizing.

Further considerations included the reduction of the requirement for strategic raw materials. After long experience in this area, and after overcoming the abovementioned prejudice, it was also recognized that the CSM offers the technically most advantageous possibility for automobile manufacturers for protecting themselves from the price dependence in the case of expensive high-performance magnetic materials, the so-called rare earth element magnets (REE magnets), for hybrid and electric vehicles.

Versions of current-energized synchronous motors that were improved according to versions of the invention with regard to their emergency running properties are outstandingly suitable as a main drive motor, owing to their system properties. If a series manufacturer substitutes the previously generally used permanent magnet synchronous motor having buried magnets (IPM) by a current-energized synchronous motor, any price trend or shortage of the REE raw materials has no effect for the series manufacturer.

To increase suitability of the CSM as a main drive, the reluctance moment of the current-energized synchronous motor (CSM) may be significantly increased in the absence of the energizing by employing a selective magnetic flux barrier, for example in the form of a radial slot in the rotor pole.

Such an emergency torque is a very major advantage in the use as a main vehicle drive—but may be unimportant in certain circumstances in the case of other applications. If for any reason energizing power cannot be transmitted to the energizer windings of the rotor, the level of the torque obtained from the reluctance determines the system properties in emergency operation. The cause of the absence of the energizer power might be, for example, a failure of the rotor current controller, a short-circuit, a break in the electric supply cables, or damage to the slip rings.

Thus, according to versions of the invention, the reluctance moment of the current-energized synchronous motor itself plays a very important role in vehicle drives, especially in emergency situations when, for the abovementioned reasons, the vehicle necessarily stands, for example, on a railway track or on carriageways with heavy traffic. In such situations, the reluctance moment of the current-energized synchronous motor according to the invention makes it possible to move out of the danger area in order to approach a safe position.

However, with the traditional current-energized synchronous motor, without the reluctance barriers according to the invention, this was not possible because, as mentioned above, the available emergency torque had to be classed as insufficient after the absence of the electrical energizing.

Considering the ready manufacturability of the invention without narrowing of the basic properties of a CSM, in versions, the invention is simple to produce by providing the rotor lamellae with a slot-like recess by punching. Smaller webs may therefore remain as connecting bridges in order to give the rotor the necessary intrinsic strength. In a further development of the invention, these mechanically indispensable connecting bridges are, according to the invention, saturated by means of relatively small permanent magnets. The required quantity of magnets corresponds to about 10% of the magnet mass of a hybrid-energized (energized both electromagnetically and by permanent magnets) synchronous motor (HSM) of the same size and about 6% of the permanent magnet synchronous motors of the same size.

The premagnetized permanent magnets are simply pushed into the prepared “pockets” of the flux barriers (slot sections). Without this measure, the flux barriers alone would work only after saturation of the connections with the transverse flux, which however is undesired, and would thereby give a smaller increase in reluctance and thus a lower emergency torque.

Reference in this specification to “one embodiment,” “an embodiment,” “one version,” “a version,” “one variant,” and “a variant,” should be understood to mean that a particular feature, structure, or characteristic described in connection with the version, variant, or embodiment is included in at least one such version, variant, or embodiment of the disclosure. The appearances of phrases “in one embodiment”, “in one version,” “in one variant,” and the like in various places in the specification are not necessarily all referring to the same variant, version, or embodiment, nor are separate or alternative versions, variants or embodiments mutually exclusive of other versions, variants, or embodiments. Moreover, various features are described which may be exhibited by some versions, variants, or embodiments and not by others. Similarly, various requirements are described which may be requirements for some versions, variants, or embodiments but not others. Furthermore, as used throughout this specification, the terms ‘a’, ‘an’, ‘at least’ do not denote a limitation of quantity, but rather denote the presence of at least one of the referenced item, and the term ‘a plurality’ should be understood to denote the presence of more than one referenced items.

Further advantages, variants and details of versions the invention are given below in the description of the Figures and in the accompanying detailed description.

### BRIEF DESCRIPTION OF THE DRAWINGS

The invention is illustrated in the attached drawings with reference to exemplary versions of hybrid synchronous motors and current-energized synchronous motors according to the invention.

FIG. 1 shows a cross-section of a version of current-energized synchronous motor, with magnetic flux lines;

FIG. 2 shows a diagram of an embodiment of the synchronous motor according to FIG. 1 as a result of the design process;

FIG. 3 shows a further side view of the rotor of the synchronous motor according to FIG. 1 without magnetic flux lines;

FIG. 4 shows a view of an exemplary version of the rotor geometry;

FIG. 5 shows a view of a part II in FIG. 4, on an enlarged scale;

FIG. 6 shows a view of a part III in FIG. 5, on a proportionally enlarged scale;

FIG. 7 shows a partial view of another version of the rotor geometry (60° sector);

FIG. 8 shows yet another version of the rotor geometry for a HSM, in this view with six rotor poles;

FIG. 9 shows a partial view VI in FIG. 8, on a proportionally enlarged scale;

FIG. 10 shows a partial view VII in FIG. 9, on a proportionally enlarged scale; and,

FIG. 11 shows a further partial view in FIG. 9, on a proportionally enlarged scale.

### DESCRIPTION OF EXEMPLARY VERSIONS OF THE INVENTION

Cross-Section of the Rotor and Stator

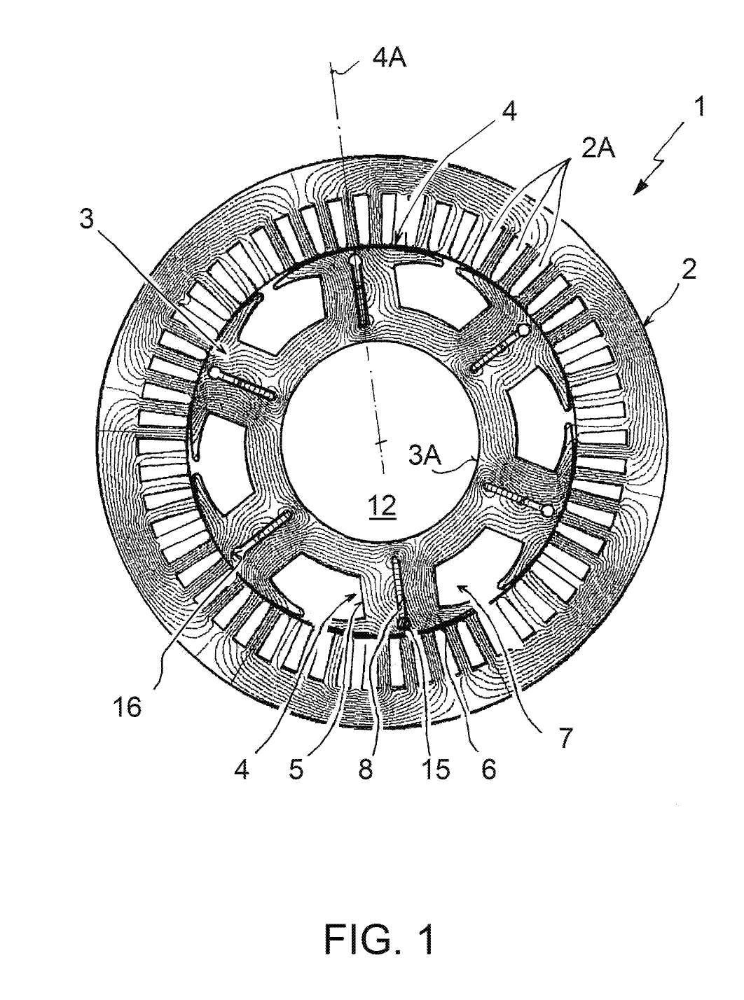

FIG. 1 schematically shows a cross-section of a working example of a current-energized synchronous motor 1 according to the invention, which is formed in particular for vehicle drives. The synchronous motor 1 is provided with an external stator 2 and an internal rotor 3. The stator 2 is provided in a manner known per se with grooves for a distributed winding 2A.

Rotor Geometry

In the working example depicted, the rotor 3 has a six-pole design (a two-pole, four-pole, eight-pole, etc., rotor is optionally also possible). FIG. 1 illustrates the rotor 3 having salient poles 4 whose pole shank and pole shoe are designated by 5 and 6, respectively. One energizer winding 7 each which is arranged along the pole shank 5 and is represented as a cross-sectional area in the diagram is coordinated with each of the rotor poles 4 in a manner known per se.

Flux Barriers Along the Main Pole Axis

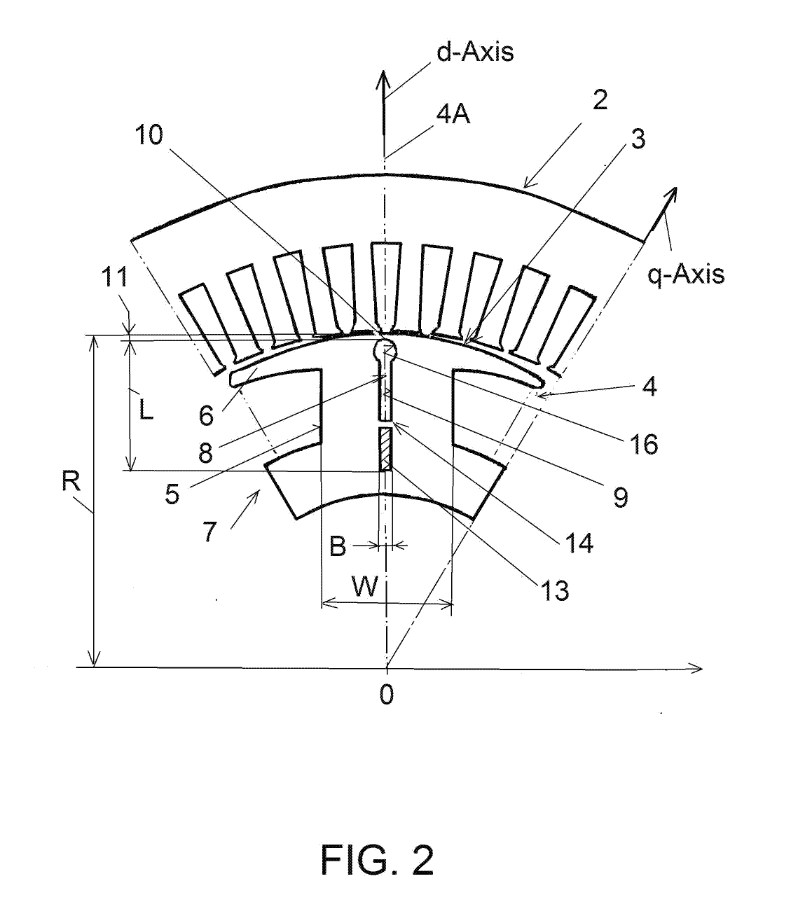

According to the invention, a completely novel rotor geometry is presented. There is provided at least one selective magnetic flux barrier, preferably in the form of a slot 8 along the main axis 4A of the rotor pole 4 in each rotor pole 4 for increasing the reluctance moment of the current-energized synchronous motor 1. The slots 8 acting as a flux barrier are preferably formed in the pole shanks 5 as central and radial longitudinal openings having substantially parallel lateral surfaces 9 (cf. FIG. 2), although the possibility of selective deviations from strict parallelism should be understood.

Regarding the more important dimensions and the mutual arrangement of the slot 8 and of the rotor pole 4, it is evident in the case of this working example in FIG. 2 that the relatively narrow radial slot 8 has a length L and a width B. According to experiments by the inventors, in this version, the length L of the slot 8 is from ¾ to ⅚ of the rotor radius R minus the radius 3A of the drive shaft 12, and the width B of the slot 8 is between 1/10 and 1/15 of the shank width W.

When viewed in the radial direction, the outermost point 10 of the slot 8 is arranged a distance 11 from the outer pole surface of the pole shoe 6 in such a way that a cap nut fitting the threaded bolt therefore does not project beyond the outer shank pole surface. The pole caps and the rotor lamellae packet are joined by the threaded bolts, as connectors, to give a whole unit.

Presaturation of Webs and Bridges in Flux Barriers

In a preferred embodiment of the current-energized synchronous motor according to the invention as shown in FIG. 2, a relatively small permanent magnet 13 (e.g. altogether 0.2 kg magnet/50 kW rated power) is arranged in the radially inner section of the slot 8 (pocket). The already premagnetized solid-state magnet 13, which is itself a flux barrier, is dimensioned so that its flux lines produced by it are just sufficient to saturate the webs 14 in the flux barrier which are provided for structural reasons but are magnetically conductive per se. The webs 14 presaturated in this manner then represent a high resistance for each further magnetic flux. They therefore behave like an extension of the slot 8 with respect to the useful flux during operation. Their magnetic conductivity which is troublesome for this application is eliminated by the inserted magnet 13.

The web 14 is mechanically advantageous for taking up the resultant centrifugal forces or the compressive forces of the shaft fit between shaft and rotor 3. It is designed precisely according to strength considerations and tailored to the application.

The intended saturation of a mechanically motivated break in the flux barrier in the quadrature axis (q-axis in FIG. 2) of the shank pole motor 1 with a permanent magnetic 13 which is introduced exclusively for this purpose therefore constitutes a fundamental further development of the invention which can also be used in certain circumstances in electric drives regardless of the application described. In this respect, the invention is therefore not limited to a CSM.

Wherever lamellar bridges are required for strength reasons but magnetic flux barriers are more advantageous such magnets can be used for eliminating the magnetic conductivity of the lamellar bridges.

Joining Methods

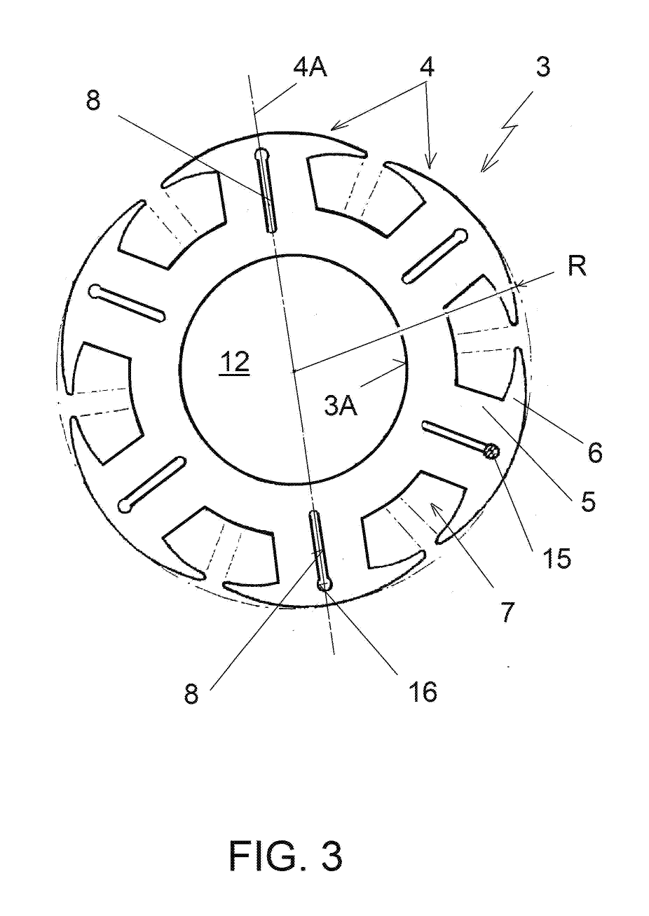

Although it was not depicted in detail, the rotor 3 may also include traditional lamellae, end plates and a connector 15 (for example, connecting bolts) which connects rotor lamellae packet and end plates to one another to give one piece (in FIGS. 1 and 3, only a sectional picture thereof was shown). According to the present invention, the connector 15 should preferably be arranged within the slot 8 acting as magnetic flux barrier. The connecting bolts of the connector 15 are inserted into the rotor lamellae and end plates through holes 16 which in the embodiment illustrated, as viewed in the radial direction, practically form the outer end of the slots 8 acting as a flux barrier. In this case, the holes 16 may have a diameter of about 5.2 mm in order to receive a, for example, approximately 5 mm thick clamping bolt.

Improvements Compared with the Prior Art

Increase in the Reluctance

With the flux barriers, the reluctance increases significantly according to the invention, and with it, the available reluctance moment increases by the factor three to four in comparison with embodiments without flux barriers.

Performance Data of the Working Example Shown

In an investigated machine with 85 Nm nominal moment, experiments by the inventors have shown that an emergency moment of 72 Nm, i.e. almost 90% of the nominal moment, may be realized with the proposed reluctance barriers. Without the reluctance barriers according to the invention, a comparable rotor, which would be manufactured according to the prior art, could generate only about 20 Nm emergency moment without energizing, which is too little for its use as a main drive, even in emergency operation.

The CSM shown can output 320 Nm in short-term operation and with intact energizing. If it is additionally equipped according to the invention with the proposed reluctance barrier, it also has substantially improved emergency properties at lower additional costs. The originally advantageous system properties of the CSM are, however not adversely affected by the reluctance barrier because the CSM according to the invention, too, can be operated with a very high power factor in all operating states and can output a constant power in a wide speed range (greater than 1:5) at very high efficiency.

Summary of the effects, considering FIGS. 1-3: In the preferred current-energized synchronous motor according to FIGS. 1-3, the ratio of the inductance of the longitudinal axis (d-axis) to the inductance of the transverse axis (q-axis in FIG. 2) is accordingly increased well beyond the normal degree of a conventional salient-pole machine as a result of the introduction of a flux barrier running along the d-axis (i.e. a slot 8), the mechanically required residual width in the vicinity of the axis preferably being completely saturated by a permanent magnet 13 introduced into this flux barrier with the result that the effect of the flux barrier is both displayed in the region of the bridges and continues through the web to the axis.

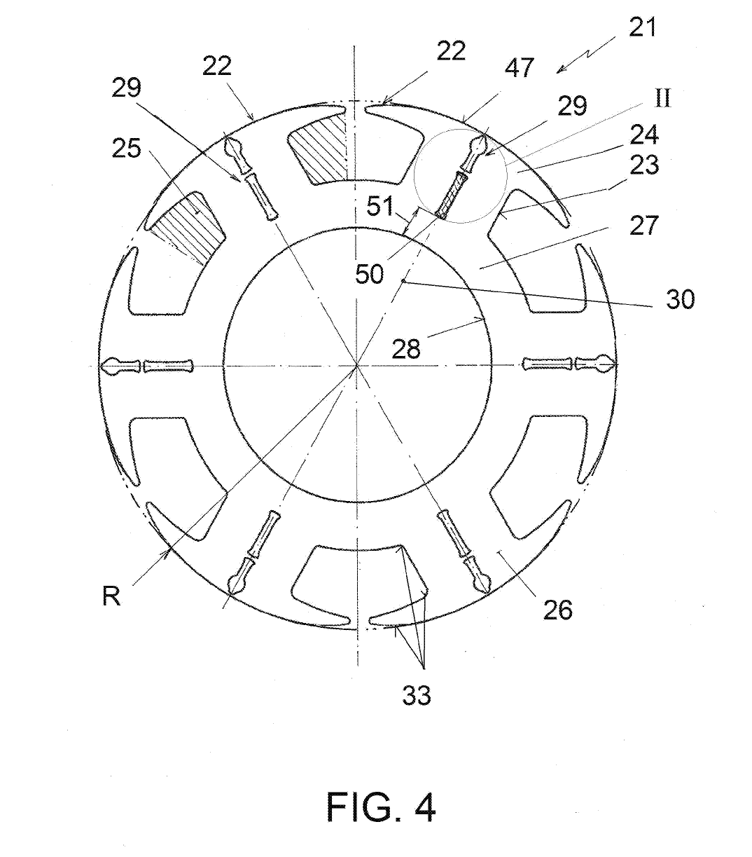

FIG. 4 shows diagrammatically the view of another example version of the rotor 21 (without rotor shaft), which is provided for a current-excited synchronous motor (CSM), for example suitable for vehicle drives. In this example version, the rotor 21 is a six-pole type; however, if applicable, two-pole, four-pole, eight-pole, etc., rotor geometries also lie within the scope of the invention. The rotor poles are designated in FIG. 1 by label 22.

This rotor 21 is illustrated in FIG. 4 as a salient pole rotor, wherein each of the rotor poles 22 has a pole shank 23 and a pole shoe 24. Each rotor pole 22 is provided in a manner known, per se, with an exciter winding 25, which is arranged around the pole shank 23. The cross-section of the exciter winding 25 is illustrated only diagrammatically and hatched in FIG. 4.

The rotor 21 in this version includes a stack (bundle) of uniform rotor plates 26 that are combined in a manner known per se, for example glued, welded, or connected by a positive fit (not illustrated).

In FIG. 4 it may be seen that the lamination changes here from a closed ring element—technically designated as hub 27—to six rotor poles 22 connected externally thereon, that are respectively wound around with the wire (for example, copper wire) of the exciter windings 25. A central opening of the rotor 21 to receive the rotor shaft (not illustrated) is designated by 28.

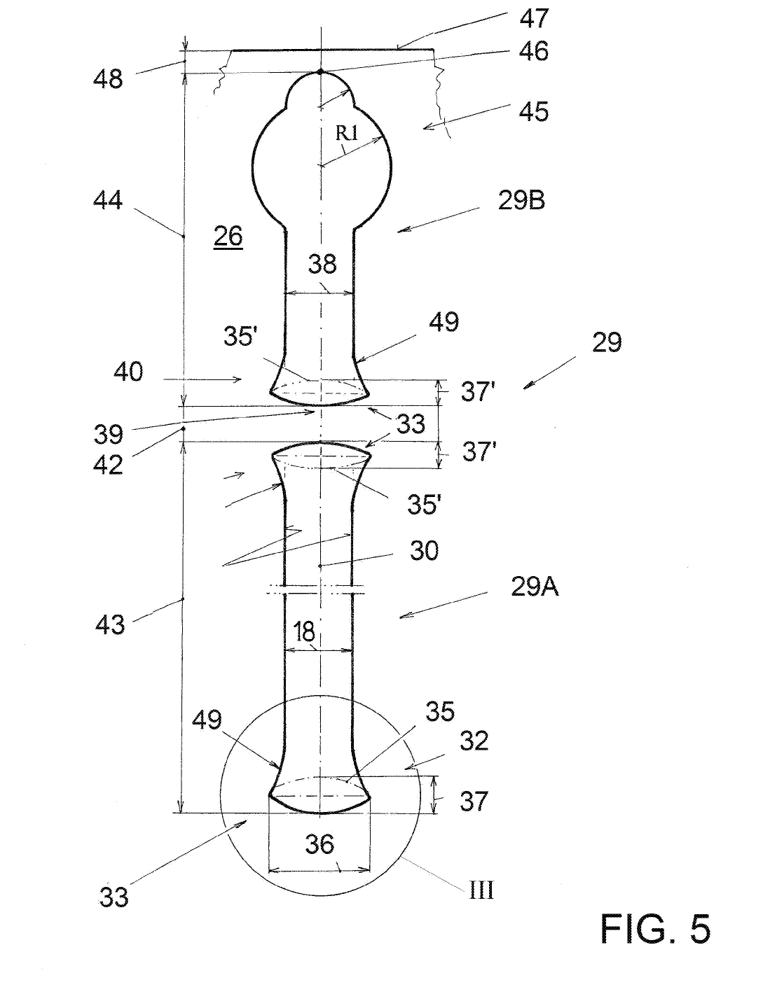

In each rotor pole 22, a radial recess acting as a flux barrier is provided, i.e. a slit 29 along a pole axis 30. The recesses or slits 29 are configured here in the rotor poles 22 as central longitudinal openings with substantially parallel edges or side faces 31 (FIGS. 4 and 5).

The dimensions and the relative arrangement of the slit 29 in a rotor pole, or respectively the rotor poles 22 of this example version itself are to be seen in FIGS. 4 and 5. Through the present invention, a novel rotor geometry is indicated and, optimized mechanically.

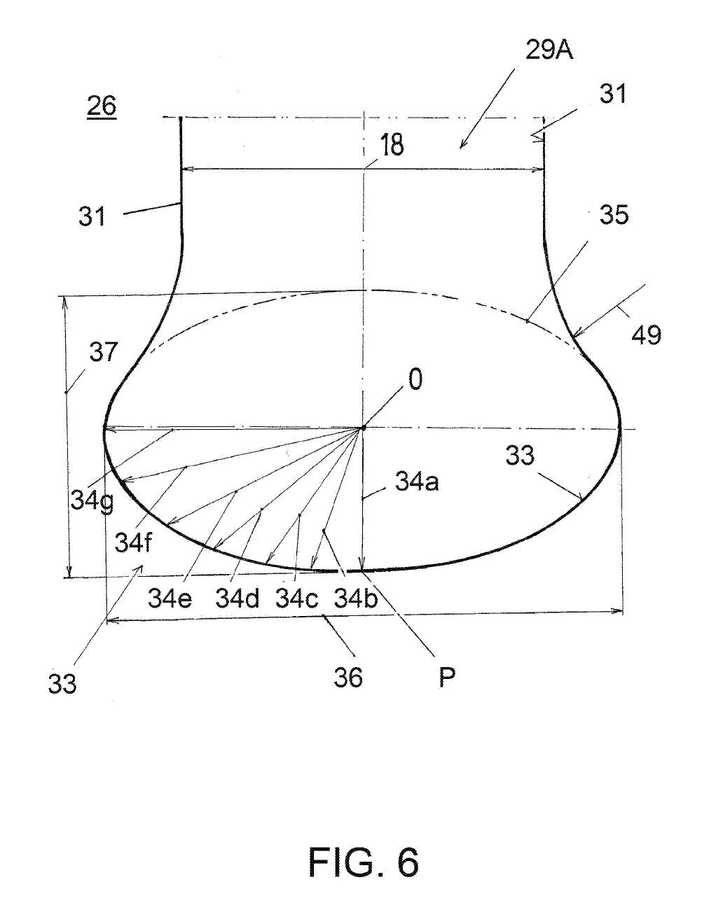

The radial slit 29 in the rotor plate 26 is configured elliptically at least at its origin, i.e. at the radially inner end 32 of the slit 29 in its transition region 33, i.e. with a continuous increase of the distances 34a . . . 34g from an intersection O of a main axis 36 and a secondary axis 37 of an ellipse 35, in order to reduce the notch stresses—as greatly as is practically possible—in these transition regions 33 (FIG. 6). The ellipse 35 therefore lies with its main axis 36 ideally arranged tangentially to the high radial stresses, which occur both with high pressure, necessary for torque transmission at high rotation speeds, and also with high centrifugal forces, because both forces attempt to widen the rotor radially outwardly. Thus, the ellipse 35 lies approximately transversely to the pole axis 30. In FIG. 6, the recess or slit part 29A has three transition regions 33: from the left-hand side face 31 (edge) over the radially deepest point P up to the right-hand side face 31 (edge).

In this version, the continuous increase of distances 34a-34g is configured as part of the ellipse 35 (FIG. 6). The full ellipse 35 is only illustrated by dot-and-dash lines in FIG. 6. In the inner end 32 (front face) of the radial slit 29, the ellipse 35 is therefore arranged tangentially, i.e. with its main axis 36 perpendicularly to the pole axis 30 (FIG. 5).

In the illustrated example version, the main axis 36 of the ellipse 35 is preferably longer by 40-60% than the width 38 of the slit 29. The secondary axis 37 of the ellipse 35 is preferably shorter by 70-80% than the width 38 of the slit 29. In the example version according to FIG. 6, the width 38 of the slit 29 is selected at approximately 2.5 mm, the main axis 36 at approximately 3.6 mm and the secondary axis 37 of the ellipse 35 at approximately 1.4 mm.

According to the calculations and considerations carried out, through this configuration an effective, harmonious deflection of the stresses takes place in the transition regions 33. This continuous increase in distance as a condition could, however, also be fulfilled according to the invention—as had already been mentioned above—in addition to the ellipse 35, by means of parabolae (quadratic function), hyperbolically, as polynomials of higher order or by two or more radii, continuing into each other tangentially, of circles of different diameter (approximation to the ellipse).

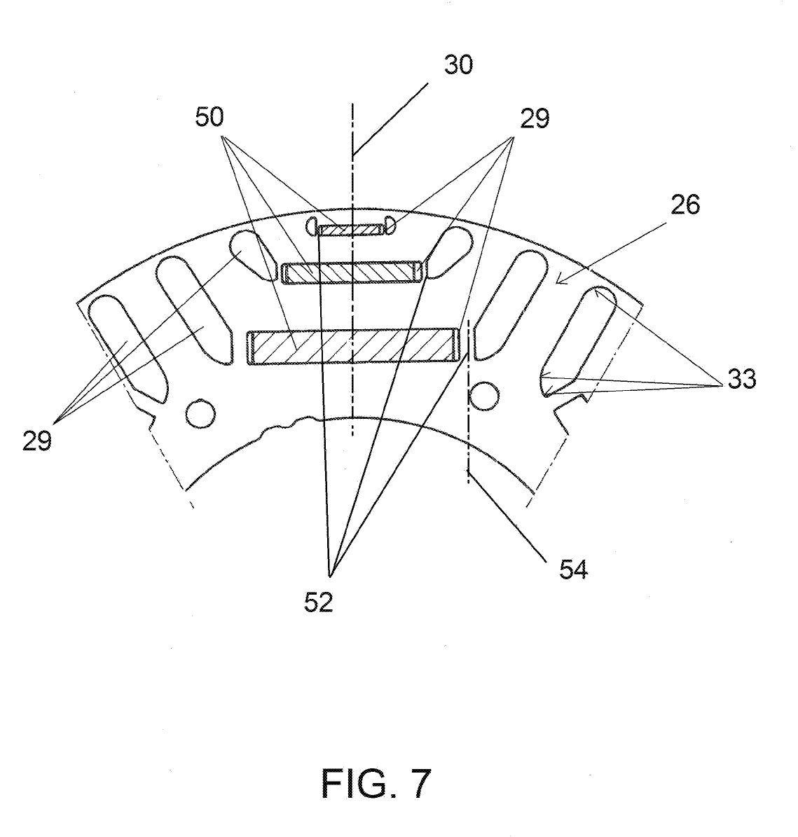

Such approximations to the ellipse may be seen, for example, in FIG. 9, and namely in the radially outer roundings of the flux barriers, which according to FIG. 9 are composed of three circles in each case with different radii, while the comparable roundings according to FIG. 7 are circular or may be configured purely elliptically. It is evidently crucial that the transition does not take place angularly or in the form of a single circle (with constant radius), but rather with a continuous increase of the distances 34a . . . 34g from the point O.

In considering also other curves of second order, by definition as according to an ellipse (hyberbola or parabola), a requirement of a “distance gradient” is also specified, i.e. the requirement of a continuous change of the distances 34a . . . 34g of the individual ellipse points from the ellipse centre point O (FIG. 6).

As may be seen in FIGS. 4-6, in this version the radial slit 29—viewed in its longitudinal axis (which coincides here with the pole axis 30)—is divided into two parts by a bridge or cross-piece 39, wherein the radially inner first slit part 29A is configured to receive a permanent magnet 50 as additional flux barrier (see also FIG. 4), and the radially outer second slit part 29B as reinforced air gap-flux barrier.

Using the teachings according to the invention, preferably the following parts may be configured elliptically and/or parabolically:
the radially inner end 32 of the slit 29, or respectively of the first slit part 29A,
the respectively inner end 32 or respectively 50 of both slit parts 29A and 29B,
the radially outer end 41 of the first slit part 29A or of the slit parts 29A and 29B;
likewise, an ellipse is also conceivable and used expediently at an outermost point 46 of the second slit part 29B.

In the present preferred example version, not only these ends 32, 40, 41 of the slit parts 29A and 29B of rotor poles 22, but at all transitions of the rotor geometry of opening or respectively recesses to the full material are configured with a distance gradient, in particular elliptically, in order to further reduce the centrifugal force-induced stresses in the rotor plate.

In the version according to FIG. 5 a width of the bridge 39 was designated by 42. The value of the width 42 of the bridge 39 is selected here at approximately 1.2 mm, and a length 43 of the inner first slit part 29A at approximately 15.5 mm, and a length 44 of the radially outer second slit part 29B at approximately 12.5 mm.

The region of an outer end 45 of the second slit part 29B is widened here circularly with a radius R1 (FIG. 5), the value of which here is about 2.6 mm. The outermost point 46 of the slit part 29B is arranged from an outer shell 47 of the pole shoe 24 at a radial distance 48, the value of which in this case is approximately 0.7 mm. In this example version, the maximum rotor radius R was selected at 82 mm (FIG. 4) and the diameter of the opening 28 of the rotor 21 was selected at 85 mm.

In FIG. 5 it may also be seen that as a rounding or curve in the transition regions 33, the same ellipse 15′ is used at the outer end 41 of the first slit part 29A and at the inner end 40 of the second slit part 29B, the secondary axis 37′ of which, however, is smaller (only approximately 1.0 mm) than the secondary axis 37 of the ellipse 35 at the inner end 32 of the first slit part 29A. The ellipses 35′ have the same main axis 36 as the ellipse 35.

In FIGS. 5 and 6, the ellipses 35 or respectively 35′ are connected with the side faces 31 (edges) of the slit 29 by a radius 49, the value of which was selected here at approximately 5.0 mm. In FIG. 4 a radial distance between the opening 28 and an innermost point P (see also FIG. 6) of the slit 29 was designated by 51. The distance 51 in this case has a value of 10.0 mm.

The rotor geometries according to the invention open up new possibilities for the motor designers, which are based on the following findings:

As the prior art offers no basic principles for a motor type of the current-excited synchronous motor in this structural and output size, extensive tests, calculations and modelling were carried out by the inventor for the realization of the above concepts. In the first step, the cylinder press fit between rotor shaft and plate stack of the rotor was tested. Particularly in the upper rotation speed range 8000 to 12000 rpm, a distinct difference in operating behaviour was able to be established here when compared with previous plate stacks as in the hybrid synchronous motor or in an IPM (motor excited by interior permanent magnets).

In the comparison of these two laminations—with regard to the joining pressure—a reduction of about 70% was able to be established at the maximum rotation speed. As the widening of the hub 27 with respect to the shaft—owing to the greater median diameter and the greater centrifugal force connected therewith—increases more rapidly, with an increasing rotation speed the interference fit, and hence the joining pressure, decreases. Therefore, according to the invention with the geometry of the current-excited synchronous motor an increase of the interference fit is definitively preferred, in order to thereby prevent a lifting of the rotor hub, even at high rotation speeds. This lifting must be prevented in order to ensure the torque transmission between rotor shaft and plate stack in all operating situations. For this reason here according to the invention the identical joining pressure between rotor shaft and hub is to be aimed for as in closed laminations according to the prior art known, per se, similar to FIG. 7.

Based on these findings according to the invention, the geometry of the rotor plate 26 was able to be dimensioned more objectively with regard to stability. In order to prevent a failure of the final rotor stack in operation, the necessary components were tested with regard to stresses and were successfully adapted geometrically.

The geometry of the proposed rotor plate 26 also influences very positively the lifting behaviour of the rotor 21 from the shaft. With a maximum rotation speed of 12000 rpm, a minimum joining pressure of 6122 MPa, and a maximum joining pressure of 14862 MPa—according to tolerance position—there were measured in a prototype the lifting of the rotor hub from the rotor shaft employing the rotor geometry according to the invention. The significant increase of the rotation speed lower limit for the lifting of the rotor hub from the machine shaft constitutes an original, previously unrealized, and very advantageous technical effect.

The dimensioning of the lamination (by use of the Finite Element Method) takes place through an analysis on the model of the 60° segment, which was already used for the calculations of the cylinder press fit. The recess (the radial slit 29) is situated in the pole axis, which serves to increase the reluctance moment of the available torque without exciting current. This characteristic is of crucial importance for the CSM for obtaining the emergency operating characteristics (in vehicle drives) in the case of fault.

Viewed physically, this flux barrier separates from each other the two magnetic flux lines, with run in opposite directions, and prevents too great a phase shift between the current axis and the field axis. Therefore, the torque which is produced may also nevertheless be kept at the nominal torque without a current supply of the rotor winding (for example, also in an emergency operation).

For this reason, the dimensioning of this flux barrier is accorded increased attention. Ideally, the pole would be completely separated through in the vertical axis. As this is not possible, however, for mechanical reasons, the flux barrier becomes as large as possible and the remaining mechanical connections, which are designated as “magnetic bridges”, are preferably saturated magnetically by a permanent magnet or by the basically present magnetic flux. As soon as the bridges are saturated, they act as flux barriers. In this way, a complete separation of the two regions is achieved with regard to the magnetic flux.

Tests showed that without the present invention, with a standard dimensioning, at 12000 rpm in the rotor plate stress peaks are reached with respect to the comparison stress according to MISES of over 870 MPa.

The parameters, influencing each other reciprocally, formed a vicious circle which is broken only by the present invention. Through the invention, it becomes possible for the first time to offer CSMs in the same overall size as IPMs with at least the same performance and with an identical rotation speed range.

In the region of the flux barrier (of the radial slit 29), enormous notch stresses occurred at the geometric transitions from the horizontal into the vertical. With conventional roundings, stress peaks additionally occurred at the tangential transitions. Through the invention, and factually confirmed by variational calculus, the stresses were able to be reduced to a minimum by geometric alterations, wherein the shape of an ellipse ultimately produced the transition with the least stresses. This is evidently to be attributed to the continuous increase of the distance towards the notch.

The ellipse 35 is therefore (FIGS. 4-6) to be configured “recumbent”, i.e. the main axis 36 perpendicular to the slit 29 or respectively tangentially at the end of the radial slit 29. By definition, notch stresses are a concentration of stresses as a result of force deflections on notches and projections. According to the invention, the force deflection can be configured more “harmoniously”, which is an important advantage of the invention. The stresses in the lamination are dominated by the radial stresses in the peripheral direction and these undergo a deflection in the region of the recess (slit 29). Through the ellipse 35 with its continuous distance increase, this force deflection takes place particularly harmoniously.

FIG. 7 illustrates a partial view of a second version of the geometry having a rotor plate 26 of a rotor 21 for a HSM. Here, the rotor plate 26 is provided with recesses 29 as flux barriers, wherein a first group of the recesses 29 is configured, with respect to the diameter, as approximately radial slits. Another group of the recesses 29, however, is configured as tangential slits (magnet pockets) with in each case a permanent magnet 50. In this version, mechanically highly stressed transition regions 33 of all recesses 29 are configured elliptically.

Between the adjacent recesses 29 in each case a cross-piece 52 is provided, the width of which is to be configured as narrow as possible for saturation purposes and is to withstand the centrifugal forces mechanically. As may be seen from FIG. 7, in this version the cross-pieces 52 have a parallel position to the pole axis 30. A center line of the cross-piece 52 is designated in FIG. 7 by reference number 54.

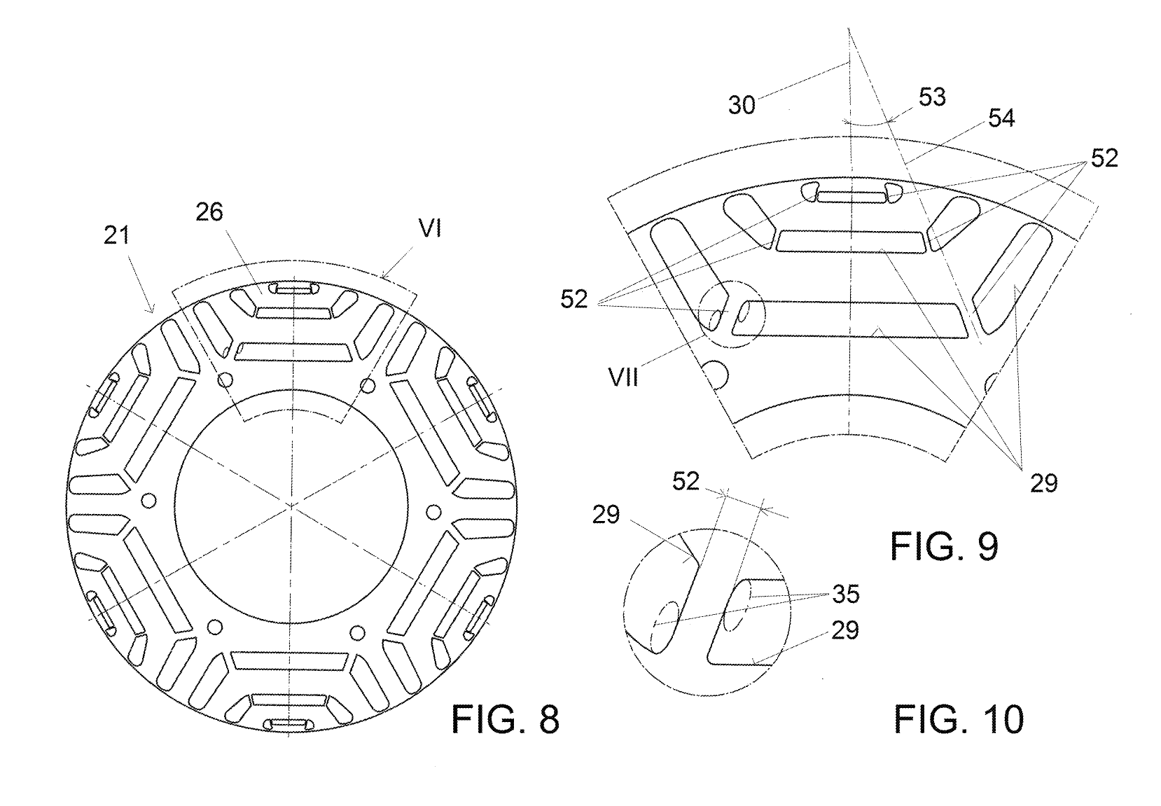

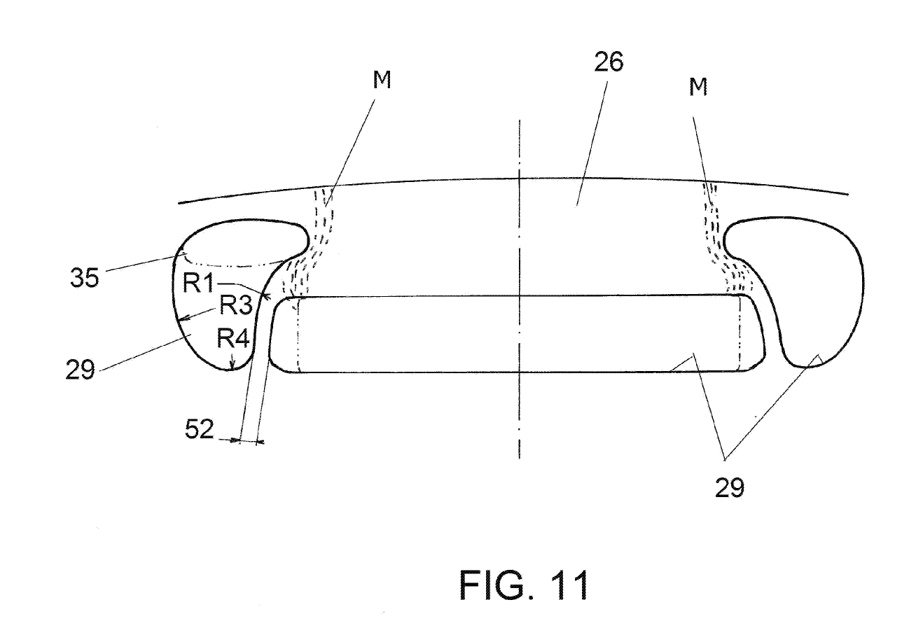

FIGS. 8-11 illustrates a third preferred version of the geometry according to the invention of a rotor plate 26 of a rotor 21 for a HSM, wherein FIG. 8 is a complete view of the rotor plate 26, FIG. 9 a partial view VI in FIG. 8 on a proportionally enlarged scale, and FIGS. 10 and 11 is/are each a partial view in FIG. 9, on a proportionally likewise enlarged scale.

The plate geometry for the HSM according to FIGS. 8-11 differs from the version according to FIG. 7 substantially in that here the center lines 54 of the cross-pieces 52 between the adjacent recesses 29 in the rotor plate 26 are configured obliquely to the pole axis 30, preferably at an angle 53 of approximately 10-50°, in particular 30°.

The reasons for the inclination of the cross-pieces 52 according to the invention may be summarized as follows:
At high rotation speeds, powerful centrifugal forces impinge and draw the cross-pieces 52 in the direction of the pole axis 30, because in radial direction of the pole axis, owing to the material accumulation by permanent magnets and the additional pole iron between the permanent magnets the greatest centrifugal forces occur in this direction; through the inclination according to the invention it is achieved that with the greatest stresses, the cross-pieces 52 are mostly stressed in longitudinal direction to tension and are stressed as minimally as possible to bending stress, in order to thus prevent signs of material fatigue in the cross-pieces 52 and hence to reduce the risk of fracture;
The local notch effect at the force deflection sites is reduced by the use of the ellipses 35;
The stresses in the cross-pieces 52 can be reduced continuously with an increasing inclination.
Through the inclination of the cross-pieces 52, in connection with the improved embodiments of the transitions (ellipses), a symbiotic effect is produced, which reduces the notch effect still further.

In versions of the present invention therefore, through the oblique cross-pieces 52 and the special, in particular elliptical transitions of the recesses 29, a significant reduction of the mechanical stresses may be achieved in the rotor plate 26.

Through this stress reduction, inter alia the following conclusions result:
the oblique cross-pieces 52 can be configured distinctly narrower, which is connected with a saving on material with regard to magnet material and hence with a certain saving on weight, or
the oblique cross-pieces 52 can be configured distinctly narrower and with an unchanging magnet mass the performance of the machine increases with regard to torque and output, or
the security of the rotor 21 or respectively of the machine (with regard to the maximum rotation speed) can be distinctly increased.

FIG. 11 illustrates a further partial view in FIG. 9, wherein the special ham- or kidney-like shape of the two radially outermost recesses 29 of the rotor plate 26 (alongside the smallest magnets) may be seen in a proportionally enlarged scale. All the curve shapes of all radially outwardly lying recesses 29 comprise here either a part of an ellipse 55 lying flat and approximately tangential to the periphery of the rotor (the full ellipse 35 is only illustrated in dot-and-dash lines in FIG. 11), or of at least two radii, running into each other, with different sizes, so that practically an ellipse is approximated. Therefore, for example, to the right and left, two smaller radii could be used and in the centre, pointing radially outwards, one larger radius could be used.

In FIG. 11 it may also be observed that here a radius R2 or respectively R3 is connected in each case to the ellipse 35 on both sides, which radii are connected with each other by the lower radius R4. As has been described more extensively above, the cross-pieces 52 also alongside the smallest magnets 50 have a special oblique arrangement in this version, i.e. the centre line 54 of the cross-pieces 52 between the adjacent recesses 29 in the rotor plate 26 stands at an angle 53 obliquely to the pole axis 30, the value of which is approximately 10-50°, in particular 15-30°.

Through the curve shape according to the invention (ham- or kidney-like shape with elliptical end regions) of the recesses 29 (FIG. 11)—apart from the advantageous stress reduction against fracture—it is achieved that they form a “magnetic lens” (focussing lens on magnetic flux lines M), and they bundle or respectively deflect the magnetic flux lines M also from the radially outermost small magnet approximately in radial direction (FIG. 11). On the other hand, the oblique cross-piece shape reduces the extremely high notch stress, because the force deflection is reduced.

As a result, the HSM with, for example reduced magnet mass, may be lighter, more stable with regard to mechanical stress and has a greater torque, owing to the magnetic lens in the outer region. (The structure according to FIG. 7 may be less preferred in this respect owing to these differences.)

It is also to be mentioned that at least the rotor plates 26 according to the present invention (if applicable, however, also the stator plates) are preferably constructed from an iron-cobalt alloy. Thereby, further increase in performance and insensitivity to temperature, and less lost heat of the electric motor can be achieved. With this alloy, preferably approximately 50% cobalt with approximately 50% iron may be alloyed.

With such a “cobalt plate”, surprisingly even about 40% more torque is produced with otherwise identical machine design of a HSM (compared with a HSM with conventional iron plates). An ideal structure is therefore found especially for electric high performance racing engines. Therefore, this measure is also to be regarded as new and significant.

If applicable, these iron-cobalt plates may also be configured permanent-magnetically, which achieves the effect that the magnetic fields produced by the permanent magnet (HSM) or by the electromagnet (CSM) lead to a magnetization of the rotor plate 26. This does not play an essential role in the HSM. In the CSM, on the other hand, this results in that also after the switching off (failure) of the exciting current, nevertheless a rotor magnetic field is present, which can still be used for torque generation. In the stator, where the magnetic polarity changes, on the other hand, preferably no permanently magnetic plates come into use.

As mentioned, the measure according to versions of the invention, the use and broadening of the ellipse (or other curves of second order) to other laminations, and preferably to all transition regions of the recesses 29 is considered extremely important in practice. According to versions of the invention, the notch stresses in the rotor plate 26 in the HSM were even able to be reduced by 25%, which is likewise a surprising effect of versions of the invention.

The laminations of electric motors are definitely very varied. In principle at least all transitions of the recesses 29 lying close to the shaft (close to the inner geometry) (transitions stressed with high stresses) may be configured in this manner according to the invention. This geometry could also even be used to reduce bending stresses.

It is also emphasized, that the systematic reduction of notch stresses preferably by ellipses in the transition regions 23 in the outer region, in addition to mechanical advantages also brings magnetic advantages, and therefore a somewhat increased efficiency, because thereby the magnetic short-circuits can be significantly reduced in the outer region. The above reduction of the magnetic short-circuit face (owing to the ellipses 35) in the outer region of the rotor 21 and hence an increase in the efficiency also belong to the overall aim of increasing the performance and, simultaneously, improving stability of the motor.

The version of rotor plate construction, with the ellipses 35 at the transition regions 33, in combination with the oblique cross-pieces 52, makes possible significant reduction of the stresses in the sites which are at risk of fracture (i.e. at transitions of the cross-pieces 52 to the solid material of the rotor plate 26). Tests confirmed that, through the proposed oblique cross-pieces 52, the cause of stress can be significantly mitigated and through the ellipse 35 the stress effect can be effectively reduced; that through both measures, therefore, symbiotically, an improvement of the rotor is produced in terms of the objectives.

Although the rotor geometry may be linked with a slightly increased production expenditure in regard to tools, the use of an ellipse or parabola in the transition regions 33 of the recesses is nevertheless categorically advisable in cases of application where high demands are made with regard to stability.

It is also to be noted that the oblique cross-pieces 52 are relatively longer. Therefore, with an oblique cross-piece 52 the magnetic path is also somewhat longer and therefore its disrupting, flux-deviating effect is somewhat reduced. The proposed oblique cross-pieces 52 therefore offer a greater resistance to the magnetic field and in such a way also act more quickly in a saturated manner, i.e. “non-magnetically” for a further flux.

An even more important aspect, from a practical point of view, of the use of the proposed oblique cross-pieces 52 is observed in that the mechanical stresses decrease by 30% with the inclination, and thereby:
the oblique cross-pieces 52 may be configured distinctly narrower, which is connected with a saving on material with regard to magnet material and hence with a certain saving on weight, or,
the oblique cross-pieces 52 may be configured distinctly narrower, and with unchanging magnet mass the performance of the machine increases with regard to torque and output, or,
the security of the rotor, or respectively of the machine (with regard to the maximum rotation speed) may be distinctly increased.

Through the use of the present invention and its subsequent analysis by means of the Finite Element Method with the ANSYS software, based on the model of a 60° segment, which was also used for testing the cylinder press fit, it is found that the slit can be provided without disadvantage, and serves there to increase the reluctance moment—of the available torque in the absence of exciting current.

This characteristic is of crucial importance to the CSM for obtaining the emergency operating characteristics in the case of fault, and is to be preferred for an electric car equipped according to the invention. If, in addition, a permanent-magnetic rotor plate were to be selected, this effect may be further intensified.

This flux barrier separates from each other the two magnetic flux lines, which run in opposite directions, and prevents too great a phase shift between the current axis and the field axis. Therefore, the torque which is produced can nevertheless be kept at the nominal torque without current supply of the rotor winding, which plays a very important role in electric cars without regard to functional security.

Through the invention, the entire rotor stack changes, and therefore the Hybrid Synchronous Motor (HSM) (and if applicable—according to the use of the invention—also the current-excited synchronous motor CSM). The invention therefore offers an improved lamination which handles the high forces in the rotor plate better than in the prior art, because due to the high centrifugal forces with high angular speeds—in particular at revolutions of about 12000 rpm—in operation the laminations are intensively stressed.

Further versions, embodiments, or variants of the present invention, and also combinations thereof, are also yielded to the reader's conception within the framework of the scope of protection according to the present disclosure and enclosed claims, for which however, given the knowledge of imparted by the present disclosure of the invention, an artisan in this art after reading or receiving the teachings herein, needs no further technical information. Thus in closing, it should be noted that the invention is not limited to the abovementioned versions and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

### LIST OF REFERENCE LABELS

1—motor
2—external stator
2A—distributed winding
3—internal rotor
3A—radius
4—salient pole
4A—main axis of rotor pole
5—pole shank
6—pole shoe
7—energizer winding
8—slot
9—lateral surfaces
10—outermost point
11—distance from outer pole surface
12—drive shaft
13—permanent magnet
14—web
15—connectors
16—holes
21—rotor
22—rotor pole
23—pole shank
24—pole shoe
25—exciter winding (cross-section)
26—rotor plate
27—hub
28—central opening (joint diameter)
29—recess/slit, or contour section
29A—first slit part
29B—second slit part
30—pole axis
31—side face/edges (recess/slit 29)
32—inner end (of slit or of first slit part 29A)
33—transition region
34a, . . . , 34g—distance from intersection of the main—and secondary axis
35 and 35′—curve of second or higher order, preferably ellipse
36—main axis (of ellipse)
37 and 37′—secondary axis (of ellipse 35 or 35′)
38—width (of slit)
39—bridge
40—inner end (of second slit part 29B)
41—outer end (of first slit part 29A)
42—width (of bridge 39)
43—length (of first slit part 29A)
44—length (of second slit part 29B)
45—outer end (of second slit part 29B)
46—outermost point (of second slit part 29B)
47—outer shell (contour section of rotor pole)
48—radial distance
49—radius
50—permanent magnet
51—distance
52—cross-piece
53—angle
54—centre line (of cross-piece)
B—width
L—length
W—shank width
q—quadrature axis
M—magnetic flux lines
O—intersection (of main and secondary axis of ellipse)
P—radially innermost point of recess/slit
R—rotor radius
R1—radius (of second slit part 9B)
R2—radius
R3—radius
R4—radius

What is claimed is:

1. An electric machine rotor assembly comprising:
a rotor piece, said rotor piece having a central axis, said rotor piece having a radial extent from said central axis;
a first magnet pocket recess disposed in said rotor piece and transversely to a radius of said rotor piece, said magnet pocket recess having a major axis coinciding with a chord segment of a rotor circle delineated by said radial extent;
said magnet pocket recess having a radially-outer top wall;
said magnet pocket recess having a radially-inner bottom wall;
said magnet pocket recess having a first end closing between said radially-outer top wall and said radially-inner bottom wall, and said magnet pocket recess having a second end closing between said radially-outer top wall and said radially-inner bottom wall;
a first flux barrier recess located proximate to said first end, said first flux barrier recess separated from said first end by a first oblique crosspiece lying obliquely at an angle in the range of 10°-50° relative to a radius of said rotor piece that passes through a center of said magnet pocket recess, said first flux barrier recess having a respective upper wall, and said first flux barrier recess having a respective lower wall;
a second flux barrier recess located proximate to said second end, said second flux barrier recess separated from said second end by a second oblique crosspiece lying obliquely at an angle in the range of 10°-50° relative to a radius of said rotor piece that passes through a center of said magnet pocket recess, said second flux barrier recess having a respective upper wall, and said second flux barrier recess having a respective lower wall;
a pocket recess first outer transition region between said radially-outer top wall and said first end, a pocket recess first inner transition region between said radially-inner bottom wall and said first end, a pocket recess second outer transition region between said radially-outer top wall and said second end, a pocket recess second inner transition region between said radially-inner bottom wall and said second end, a first flux barrier upper transition region between said first flux barrier respective upper wall and said first oblique crosspiece, a first flux barrier lower transition region between said first flux barrier respective lower wall and said first oblique crosspiece, a second flux barrier upper transition region between said second flux barrier respective upper wall and said second oblique crosspiece, a second flux barrier lower transition region between said second flux barrier respective lower wall and said second oblique crosspiece, each of said transition regions having a respective profile shape at least approximately in a respective form of a respective curve of second order.

2. The electric machine rotor assembly as claimed in claim 1, wherein:
each transition region's profile shape includes a respective profile shape selected from the group consisting of an elliptical profile, a parabolic profile, and a higher-order polynomial profile.

3. The electric machine rotor assembly as claimed in claim 1, wherein:
each transition region's profile shape is a respective elliptical profile.

4. An electric machine rotor assembly as claimed in claim 1, further comprising:
said rotor piece being produced from an iron-cobalt alloy.

5. An electric machine rotor assembly as claimed in claim 1, further comprising:
an outer magnet pocket recess disposed in said rotor piece and transversely to a radius of said rotor piece, said outer magnet pocket recess having a respective major axis parallel to the major axis of said first magnet pocket recess that coincides with a chord segment of a rotor circle delineated by said radial extent;
said outer magnet pocket recess having a respective radially-outer top wall;
said outer magnet pocket recess having a respective radially-inner bottom wall;
said outer magnet pocket recess having a respective first end closing between its respective radially-outer top wall and its respective radially-inner bottom wall, and said outer magnet pocket recess having a second end closing between its respective radially-outer top wall and its respective radially-inner bottom wall;
a first radially outwardly lying recess located proximate to said outer magnet pocket's first end, said first radially outwardly lying recess having a ham-like or kidney-like contour; and,
a second radially outwardly lying recess located proximate to said outer magnet pocket's second end, said second radially outwardly lying recess having a ham-like or kidney-like contour.

6. An electric machine rotor assembly as claimed in claim 5, further comprising:
an outer magnet pocket recess first outer transition region between said outer magnet pocket recess radially-outer top wall and said outer magnet pocket recess first end, an outer magnet pocket recess first inner transition region between said outer magnet pocket recess radially-inner bottom wall and said outer magnet pocket recess first end, an outer magnet pocket recess second outer transition region between said outer magnet pocket's radially-outer top wall and said outer magnet pocket's second end, an outer magnet pocket recess second inner transition region between said outer magnet pocket's radially-inner bottom wall and said outer magnet pocket's second end, each of said outer magnet pocket's transition regions having a respective profile shape at least approximately in a respective form of a respective curve of second order.

7. The electric machine rotor assembly as claimed in claim 6, wherein:
each respective transition region of said outer magnet pocket's transition regions includes a respective profile shape selected from the group consisting of an elliptical profile, a parabolic profile, and a higher-order polynomial profile.

8. The electric machine rotor assembly as claimed in claim 6, wherein:
each transition region's respective profile shape is a respective elliptical profile.

9. A laminated rotor for a hybrid synchronous motor comprising:
a plurality of rotor plates; at least one of said plurality of rotor plates having a respective plurality of recesses therein;
at least one of said plurality of recesses has an innermost edge section, and said at least one of said plurality of recesses has an outermost edge section, said innermost and outermost edge sections being at respective edges thereof in the form of respective rounded transition regions;
at least one of said innermost and outermost rounded transition regions being configured in either one of a circular or elliptical segment shape, and each of said innermost and outermost rounded transition regions being shaped to at least approximate a respective part of a respective curve of second order; and,
a cross-piece, said cross-piece located between said at least one of said plurality of recesses and a second one of said plurality of recesses that is adjacent to said at least one of said plurality of recesses, said cross-piece disposed to have a center line lying oblique at an angle in the range of 10°-50° relative to a rotor pole axis.

10. The laminated rotor for a hybrid synchronous motor as claimed in claim 9, wherein:
the angle is 30°.

11. The laminated rotor for a hybrid synchronous motor as claimed in claim 9, wherein:
said plurality of rotor plates are produced from an iron-cobalt alloy.

12. The laminated rotor for a hybrid synchronous motor as claimed in claim 11, wherein:
said iron-cobalt alloy has a proportion of 50% cobalt and 50% iron.

13. The laminated rotor for a hybrid synchronous motor as claimed in claim 9, wherein:
each respective curve of second order in said rounded transition regions is elliptical.

14. The laminated rotor for a hybrid synchronous motor as claimed in claim 9, wherein:
each respective curve of second order in said rounded transition regions approximates a respective ellipse.

15. The laminated rotor for a hybrid synchronous motor as claimed in claim 9, wherein:
each respective curve of second order in said rounded transition regions is parabolic.

16. The laminated rotor for a hybrid synchronous motor as claimed in claim 9, wherein:
each respective curve of second order in said rounded transition regions is configured according to a polynomial of higher order.

17. A laminated rotor for a hybrid synchronous motor as claimed in claim 9, further comprising:
at least one outwardly-lying recess of said plurality of recesses, said at least one outwardly-lying recess having a kidney-like interior contour.

18. An electric machine rotor assembly comprising:
a rotor piece, said rotor piece having at least one salient pole, said at least one salient pole having a shank, said shank having a radial shank axis, and said at least one salient pole having a shoe;
a magnetic flux barrier in said first salient pole, said magnetic flux barrier including a radially-extending longitudinal slot in said at least one salient pole, said radially-extending longitudinal slot having a central slot axis coincident with said shank axis, said radially-extending longitudinal slot having a first lateral side surface, said radially-extending longitudinal slot having a second lateral side surface, the distance between said first and second lateral side surfaces defining a slot width;
a radially-outermost edge section of said radially-extending longitudinal slot, said radially-outermost edge section located at a radially outer end of said radially-extending longitudinal slot;
said radially-outermost edge section including a curved outermost transition region;
a radially-innermost edge section of said radially-extending longitudinal slot, said radially-innermost edge section located at a radially inner end of said radially-extending longitudinal slot;
said radially-innermost edge section including an innermost transition region;
a bridge spanning the slot width and connected to said first and said second lateral side surfaces, said bridge dividing said radially-extending longitudinal slot into a first radially-inner slot portion and a second radially-outer slot portion;
said first slot portion having a respective outer transition region;
said second slot portion having a respective inner transition region; and,
a permanent magnet in said first slot portion, said permanent magnet configured to generate flux saturating said bridge to create high resistance for further magnetic flux in said bridge and reduce magnetic conductivity of said bridge so as to extend the effect of said magnetic flux barrier to a total region of a longitudinal axis of said first pole, said magnet having a direction of magnetization tangential with respect to a rotational direction of said rotor.

19. The electric machine rotor assembly as claimed in claim 18, wherein:
said curved outermost transition region has profile shape at least approximately in form of a curve of second order; and,
said innermost transition region is curved.

20. The electric machine rotor assembly as claimed in claim 19, wherein:
said outer transition region of said first slot portion is curved with profile shape at least approximately in the form of a curve of second order; and,
said inner transition region of said second slot portion is curved with profile shape at least approximately in the form of a curve of second order.
